(19) United States
(12) Patent Application Publication
(10) Pub. No.: US 2016/0369367 A1
(43) Pub. Date: Dec. 22, 2016

(54) HIGH-STRENGTH STEEL SHEET AND PROCESS FOR PRODUCING SAME

(71) Applicant: KABUSHIKI KAISHA KOBE SEIKO SHO (KOBE STEEL, LTD.), Kobe-shi (JP)

(72) Inventors: Atsuhiro SHIRAKI, Kakogawa-shi (JP); Yukihiro UTSUMI, Kakogawa-shi (JP)

(73) Assignee: KABUSHIKI KAISHA KOBE SEIKO SHO (KOBE STEEL, LTD.), Kobe-shi (JP)

(21) Appl. No.: 15/111,302

(22) PCT Filed: Dec. 26, 2014
(86) PCT No.: PCT/JP2014/084693

§ 371 Date: Jul. 13, 2016

(30) Foreign Application Priority Data
Jan. 14, 2014 (JP) 2014-004405

(51) Int. Cl. C21D 9/46; C25D 5/36; C23C 2/06; C23C 2/02; C23C 2/40; C22C 38/54; C22C 38/50; C22C 38/48; C22C 38/46; C22C 38/42; C22C 38/32; C22C 38/28; C22C 38/26; C22C 38/24; C22C 38/20; C22C 38/16; C22C 38/14; C22C 38/12; C22C 38/08; C22C 38/06; C22C 38/04; C22C 38/02; C22C 38/00; C23G 1/00; C21D 8/02; B32B 15/01; C25D 3/22

(52) U.S. Cl. CPC C21D 9/46; C25D 3/22; C25D 5/36; C23C 2/06; C23C 2/02; C23C 2/40; C22C 38/54; C22C 38/50; C22C 38/48; C22C 38/46; C22C 38/42; C22C 38/32; C22C 38/28; C22C 38/26; C22C 38/24; C22C 38/20; C22C 38/16; C22C 38/14; C22C 38/12; C22C 38/08; C22C 38/06; C22C 38/04; C22C 38/02; C22C 38/002; C22C 38/001; C23G 1/00; C21D 8/0236; C21D 8/0226; C21D 8/0247; B32B 15/013; C21D 2211/008; C21D 2211/005

(57) ABSTRACT

A high-strength steel sheet contains, by mass %, C: 0.12% to 0.40%, Si: 0% to 0.6%, Mn: more than 0% to 1.5%, Al: more than 0% to 0.15%, N: more than 0% to 0.01%, P: more than 0% to 0.02%, S: more than 0% to 0.01%, and has a martensite single-phase structure, wherein a region having a KAM value (Kernel Average Misorientation value) of 1° or more occupies 50% or more, and a maximum residual tensile stress in a surface layer region from a surface to a position at a depth of ¼ the sheet thickness is 80 MPa or less. As a result, the high-strength steel sheet excels in the resistance to delayed fracture of the cut end surface and the steel sheet base material.

### TECHNICAL FIELD

The present invention relates to a high-strength steel sheet and a process for producing same. More specifically, the present invention relates to a high-strength steel sheet that excels in resistance to delayed fracture of a cut end surface and a steel sheet base material, and to a process for producing the high-strength steel sheet.

### BACKGROUND ART

The strength of steel sheets for automobiles has recently been further increased to improve safety and reduce weight of automobiles. The problem is, however, that the resistance to delayed fracture of steel sheet base material is degraded as the steel sheets for automobiles are increased in strength, and the delayed fracture occurring at the cut end surfaces has recently become an especially serious problem. Since the cracks initiated by the delayed fracture occurring at the cut end surfaces are of a very small size of about several hundreds of microns, they were not considered up to now as a problem, but because fatigue properties are degraded by the occurrence of such fine cracks, reducing the cracks initiated by the delayed fracture occurring at the cut end surfaces has become an important challenge.

Since the delayed fracture at the cut end surfaces occurs at the cutting fracture surfaces, the residual stresses and strain amounts are larger than in the case of delayed fracture of the steel sheet base material occurring in the conventional molded portions, and such delayed fracture tends to occur easier than the conventional delayed fracture. Accordingly, novel techniques need to be developed to resolve this problem.

The following technique has heretofore been suggested to improve the resistance to delayed fracture. For example, Patent Literature 1 discloses improving the resistance to delayed fracture of a punched end surface by controlling spherical inclusions. However, the object investigated in this technique is the resistance to delayed fracture of the end surface after hot punching, and the resistance to delayed fracture of the end surface after cold processing in which residual stresses and strain amounts are large has not been considered.

Meanwhile, Patent Literature 2 discloses the technique for improving the resistance to delayed fracture by controlling the retained austenite grain size, dislocation density, solid-solution C concentration in martensite, and the form of carbides, as parameters, such that a predetermined relationship is fulfilled in a structure extending from a position at a depth of 10 μm in the sheet thickness direction from the steel sheet surface to a position at a depth of ¼ the sheet thickness, the structure including the martensite at 95 area % or more. With such a technique, excellent resistance to delayed fracture of the steel sheet base material can be obtained.

However, in such a technique, the resistance to delayed fracture of the cut end surfaces has also not been considered. Since the delayed fracture at the cut end surfaces occurs in a region close to a position of ½ the sheet thickness, this technique cannot be found to be effective in improving the resistance to delayed fracture of the cut end surfaces.

### CITATION LIST

### Patent Literature

Patent Literature 1: Japanese Unexamined Patent Publication No. 2012-237048

Patent Literature 2: Japanese Unexamined Patent Publication No. 2013-104081

### SUMMARY OF INVENTION

The present invention has been created with the foregoing in view, and it is an objective thereof to provide a high-strength steel sheet that excels in the resistance to delayed fracture of the cut end surface and the steel sheet base material, and also to provide a process suitable for producing such a high-strength steel sheet.

The high-strength steel sheet in accordance with the present invention which resolves the abovementioned problems satisfies, by mass %,

C: 0.12% to 0.40%,

Si: 0% to 0.6%,

Mn: more than 0% to 1.5%,

Al: more than 0% to 0.15%,

N: more than 0% to 0.01%,

P: more than 0% to 0.02%,

S: more than 0% to 0.01%,

and has a martensite single-phase structure, wherein a region having a KAM value (Kernel Average Misorientation value) of 1° or more occupies 50% or more, and a maximum residual tensile stress in a surface layer region from a surface to a position at a depth of ¼ the sheet thickness is 80 MPa or less.

The high-strength steel sheet in accordance with the present invention can also contain, as necessary, one or more selected from the group consisting of Cr: more than 0% to 1.0%, B: more than 0% to 0.01%, Cu: more than 0% to 0.5%, Ni: more than 0% to 0.5%, Ti: more than 0% to 0.2%, V: more than 0% to 0.1%, Nb: more than 0% to 0.1%, and Ca: more than 0% to 0.005%, and the properties of the high-strength steel sheet can be further improved according to the types of the contained elements.

The high-strength steel sheet in accordance with the present invention also encompasses a galvanized steel sheet in which a galvanized layer is formed on the surface of the steel sheet.

The process for producing a high-strength steel sheet in accordance with the present invention which resolves the abovementioned problems contains: heating a steel sheet having the above-described chemical composition in a temperature range from an Ac₃ transformation point to 950° C., holding the steel sheet for 30 sec or more in this temperature range, quenching the steel sheet from a temperature range of 600° C. or higher, tempering the steel sheet for 30 sec or more at 350° C. or less, and then performing correction with a leveler.

In accordance with the present invention, where the chemical composition and structure are controlled and also the region having a KAM value of 1° or more occupies 50% or more and a maximum residual tensile stress in a surface layer region from a surface to a position at a depth of ¼ the sheet thickness is 80 MPa or less, it is possible to realize a high-strength steel sheet, such as a galvanized steel sheet, which excels in resistance to delayed fracture of the cut end surfaces and the steel sheet base material. Such a high-strength steel sheet is useful as a material for producing high-strength automotive parts such as bumpers.

### BRIEF DESCRIPTION OF DRAWINGS

FIG. 1 is schematic perspective view illustrating the state of a testpiece when the residual tensile stresses of a steel sheet are measured.

FIG. 2 is a schematic explanatory drawing illustrating the observation region when measuring the number of cracks introduced during cutting.

FIG. 3 is a photo illustrating an example of cracks induced by delayed fracture occurring at the cut end surface.

### DESCRIPTION OF EMBODIMENTS

The inventors have conducted a comprehensive research to suppress the occurrence of delayed fracture at the cut end surfaces of steel sheets. The results obtained have clarified that a large number of fine cracks occur in the vicinity of the cut end surfaces. It was also considered that the occurrence of cracking initiated by the delay fracture is enhanced by this large number of fine cracks. It was found that by controlling the strained state of the steel sheet before cutting, as a means for improving the resistance to cracking induced by the delayed fracture, it is possible to reduce the number of cracks introduced during cutting.

It was also found that by changing the strained state of the steel sheet and performing control such that the region having the KAM value (Kernel Average Misorientation value) of 1° or more occupies 50% or more by performing correction with a leveler, it is possible to suppress effectively the delayed fracture of the cut end surface. The region having the KAM value of 1° or more preferably is 60% or more, more preferably 70% or more.

In the correction with a leveler, by contrast with the correction by skin pass rolling, the maximum residual tensile stress in a surface layer region from a surface to a position at a depth of ¼ the sheet thickness can be reduced and made 80 MPa or less, preferably 60 MPa or less, more preferably 40 MPa or less. Therefore, the resistance to delayed fracture of the cut end surface can be improved without degrading the resistance to delayed fracture of the steel sheet base material.

In accordance with the present invention, excellent resistance to delayed fracture of the cut end surfaces and the steel sheet base material is demonstrated as a result of controlling the KAM value, but to ensure other properties required for a steel sheet, such as weldability, toughness, and ductility, it is also necessary to control the content of constituent elements in the steel base material in the following manner.

C: 0.12% to 0.40%

C is an element necessary for increasing the quenching ability of the steel sheet and ensuring a high hardness. In order to exhibit such effects, C needs to be contained at 0.12% or more. The amount of C is preferably 0.15% or more, more preferably 0.20% or more. However, where the C amount is too high, weldability is degraded. Therefore, the C amount needs to be 0.40% or less, preferably 0.36% or less, more preferably 0.33% or less, even more preferably 0.30% or less.

Si: 0% to 0.6%

Si is an element effective in increasing the resistance to tempering-induced softening and is also effective in increasing the strength by solid solution hardening. From the standpoint of exhibiting those effects, it is preferred that Si be contained at 0.02% or more. However, since Si is a ferrite-creating element, where the amount thereof is too high, the quenching ability is lost and a high strength is difficult to ensure. Accordingly, the amount of Si is 0.6% or less, preferably 0.5% or less, more preferably 0.3% or less, even more preferably 0.1% or less, still more preferably 0.05% or less.

Mn: more than 0% to 1.5%

Mn is an element effective in improving the quenching ability and increasing the strength. In order to exhibit those effects, it is preferred that the amount thereof be 0.1% or more, more preferably 0.5% or more, even more preferably 0.8% or more. However, where the Mn amount is too high, the resistance to delayed fracture and weldability are degraded. Accordingly, the Mn amount needs to be 1.5% or less. The upper limit for the Mn amount is preferably 1.3% or less, more preferably 1.1% or less.

Al: more than 0% to 0.15%

Al is an element added as a deoxidizing agent and it also increases the corrosion resistance of steel. For those effects to be sufficiently exhibited, the amount of aluminum is preferably 0.040% or more, more preferably 0.060% or more. However, where the Al amount is too high, a large amount of inclusions is generated and they cause surface defects. Therefore, the upper limit thereof is 0.15% or less, preferably 0.14% or less, more preferably 0.10% or less, still more preferably 0.07% or less.

N: more than 0% to 0.01%

Where the N amount is too high, the amount of precipitated nitrides increases and the toughness is adversely affected. Therefore, the N amount needs to be 0.01% or less, preferably 0.008% or less, more preferably 0.006% or less. With consideration for the cost of steelmaking, the N amount is usually 0.001% or more.

P: more than 0% to 0.02%

P acts to strengthen the steel, but where the amount thereof is too high, the ductility is decreased due to the embrittlement. Therefore, the amount of phosphorus needs to be suppressed to 0.02% or less, preferably to 0.01% or less, more preferably 0.006% or less. To realize the strengthening effect exhibited by P, it is preferably contained at 0.001% or m ore.

S: more than 0% to 0.01%

S generates sulfide-based inclusions and degrades the processability and weldability of the steel sheet base material. Therefore, the lower is the amount thereof, the better. In the present invention the amount of sulfur needs to be suppressed to 0.01% or less, preferably 0.005% or less, more preferably 0.003% or less.

The basic components in the high-strength steel sheet in accordance with the present invention are described hereinabove, the balance being iron and inevitable impurities. The elements introduced according to the state of raw materials, resources, production equipment or the like can be allowed to be admixed as inevitable impurities. Further, in addition to the above-described component, the steel sheet in accordance with the present invention can effectively contain also Cr, B, Cu, Ni, Ti, V, Nb, and Ca. When those elements are contained, the suitable ranges and actions thereof are described hereinbelow.

At least one of Cr: more than 0% to 1.0% and B: more than 0% to 0.01%

Cr is an element effective in increasing the strength by improving the quenching ability. Cr is also an element effective in increasing the resistance to tempering-induced softening of the martensitic steel. For those effects to be sufficiently exhibited, the Cr amount is preferably 0.01% or more, more preferably 0.05% or more. However, where the Cr amount is too high, the resistance to delayed fracture is degraded. Therefore, the upper limit thereof is preferably 1.0% or less, more preferably 0.7% or less.

Similarly to Cr, B is an element effective in improving the quenching ability. For this effect to be sufficiently exhibited, the amount thereof is preferably 0.0001% or more, more preferably 0.0005% or more. Where the B amount is too high, the ductility is decreased. Therefore, the upper limit thereof is preferably 0.01% or less, more preferably 0.0080% or less, even more preferably 0.0065% or less.

At least one of Cu: more than 0% to 0.5% and Ni: more than 0% to 0.5%

Cu and Ni are elements effective in increasing the resistance to delayed fracture due to the improvement in corrosion resistance. For this effect to be sufficiently demonstrated, it is preferred that the amount of each element be 0.01% or more, more preferably 0.05% or more. However, where the amount of those elements is too high, the ductility and the processability of the base material are degraded. Therefore, the amount of each element is preferably 0.5% or less, more preferably 0.4% or less.

Ti: more than 0% to 0.2%

Ti immobilizes N as TiN, and when added in combination with B, effectively maximizes the ability of B to improve the quenching ability. Ti is also an element effective in increasing the corrosion resistance and also increasing the resistance to delayed fraction by TiC precipitation. For those effects to be sufficiently demonstrated, it is preferred that the Ti amount be 0.01% or more, more preferably 0.03% or more, even more preferably 0.05% or more. However, where the Ti amount is too high, the ductility or processability of the steel sheet base material is degraded. Therefore, the upper limit of titanium amount is preferably 0.2% or less, more preferably 0.15% or less, even more preferably 0.10% or less.

At least one of V: more than 0% to 0.1% and Nb: more than 0% to 0.1% V and Nb are each effective in increasing the strength and improving the toughness after quenching as a result of refining the austenite crystal grains. For those effects to be sufficiently exhibited, it is preferred that the amount of each of V and Nb be 0.003% or more, more preferably 0.02% or more. However, where the amount of those elements is too high, the precipitation of carbonitrides or the like increases, and the processability of the base material is degraded. Therefore, the amount of each of V and Nb is preferably 0.1% or less, more preferably 0.05% or less.

Ca: more than 0% to 0.005%

Ca is an element effective in forming Ca-containing inclusions which can trap hydrogen and improving the resistance to delayed fraction. For such effects to be sufficiently demonstrated, it is preferred that the amount thereof be 0.001% or more, more preferably 0.0015% or more. However, where the Ca amount is too high, the processability is degraded. Therefore, it is preferred that the calcium amount be 0.005% or less, more preferably 0.003% or less.

The steel sheet in accordance with the present invention may also contain other elements, for example, Se, As, Sb, Pb, Sn, Bi, Mg, Zn, Zr, W, Cs, Rb, Co, La, Tl, Nd, Y, In, Be, Hf, Tc, Ta, and 0 in a total amount of 0.01% or less with the object of improving the corrosion resistance or the resistance to delayed fracture.

The conditions specified by the present invention will be explained hereinbelow in greater detail.

The steel sheet in accordance with the present invention exhibits a high tensile strength of 1180 MPa or higher, preferably 1270 MPa or higher. The tensile strength may be 2200 MPa or lower. Such a high strength is required as a property of steel sheets for automobiles, for example, for bumpers. Where the structure of the steel sheet contains a large amount of ferrite to achieve such a high strength, the amount of alloying elements necessary to ensure the high strength needs to be increased. As a result, the weldability is degraded. Accordingly, the present invention specifies a structure including only martensite, that is, a martensite single-phase structure and suppresses the amount of alloying elements. The martensite single-phase structure, as referred to herein, does not necessarily require the martensite structure to take 100 area %, and is inclusive of structures in which the martensite structure occupies 94 area % or more, in particular, 97 area % or more. Therefore, in addition to the martensite structure, the steel sheet can also have a structure that is unavoidably included in the production process, for example, a ferrite structure, a bainite structure, and a residual austenite structure.

The KAM value is the average value of crystal misorientation in one measurement point and measurement points on the periphery thereof. The higher is this value, and greater is the strain amount. By adequately controlling the KAM amount by correction with a leveler, it is possible to reduce the occurrence of cracks during cutting and reduce the delayed fracture generated in the cut end surface. Where the region having a KAM value of 1° or more occupies 50% or more, excellent resistance to delayed fracture can be exhibited. The region having a KAM value of 1° or more occupies 60% or more, more preferably 70% or more. The region having a KAM value of 1° or more may occupy 80% or less.

The maximum residual tensile stress in the surface layer region from the steel sheet surface to the position at a depth of ¼ the sheet thickness needs to be controlled because it adversely affects the resistance to delayed fracture of the steel sheet base material. By setting the maximum residual tensile stress in the surface layer region from the surface to the position at a depth of ¼ the sheet thickness to 80 MPa or less, it is possible to obtain good resistance to delayed fracture. The maximum residual tensile stress is preferably 60 MPa or less, more preferably 40 MPa or less. The maximum residual tensile stress being “80 MPa or less” is also inclusive of the case in which the maximum residual tensile stress is 0 MPa or less, that is, the case, in which residual stress is a residual compressive stress. The maximum residual tensile stress may be −20 MPa or more. Where skin pass rolling is used to control the KAM value, the maximum residual tensile stress in the surface layer region from the surface layer to the position at a depth of ¼ the sheet thickness is difficult to make 80 MPa or less. For this reason, correction with a leveler needs to be used as in the below-described examples.

The production process is explained hereinbelow. In order to produce the steel sheet fulfilling the above-described requirements, the conditions of the annealing treatment need to be suitably controlled. General conditions can be used in addition to the conditions of the annealing treatment. For example, when a cold-rolled steel sheet is subjected to annealing treatment under the below-described conditions, a steel sheet can be obtained by melting according to the usual method, obtaining a steel billet such as a slab by continuous casting, then heating to about 1100° C. to 1250° C., performing hot rolling, coiling, and then pickling and cold rolling. It is recommended that the annealing treatment performed thereafter be performed under the following conditions.

The steel sheet with the above-described chemical composition is treated at an annealing temperature of Ac₃ transformation point or higher, preferably at an Ac₃ transformation point +20° C. or more to obtain an austenite single phase. Where the steel sheet is excessively held at a high temperature, the equipment load increases and the cost rises. Therefore, the upper limit is set to 950° C. or less, preferably 930° C. or less. In order to complete the austenite transformation at such an annealing temperature, it is necessary that the holding be performed for 30 sec or longer, preferably 60 sec or longer, more preferably 90 sec or longer. The upper limit of the holding time at the annealing temperature is preferably 150 sec or less. When the below-described hot-dip galvanized steel sheet or hot-dip galvanized and alloyed steel sheet is obtained, such annealing treatment can be performed, for example, in a hot-dip galvanization line. If necessary, the cold-rolled steel sheet may be subjected to electrogalvanization.

The Ac₃ transformation point of the steel sheet can be determined using the following Formula (1). Concerning the Formula (1), see, for example, William C. Leslie “Leslie Cast Iron and Steel Materials”, published by Maruzen, 1985, p. 273, Equation (VII-20).

Ac₃(° C.)=910−203×[C]^{1/2}−15.2×[Ni]+44.7×[Si]+104×[V]+31.5×[Mo]+13.1×[W]−30×[Mn]−11×[Cr]−20×[Cu]+700×[P]+400×[Al]+120×[As]+400×[Ti] (1)

In the formula, [C], [Ni], [Si], [V], [Mo], [W], [Mn], [Cr], [Cu], [P], [Al], [As], and [Ti] represent the amount of C, Ni, Si, V, Mo, W, Mn, Cr, Cu, P, Al, As, and Ti, respectively, in mass %. Where any of the elements indicated in the terms of the Formula (1) is not present, the calculation is performed by omitting the term.

After the annealing treatment, the steel is cooled from the quenching start temperature which is 600° C. or higher to a room temperature of 25° C. by rapid cooling at an average cooling rate of 50° C/sec or higher. Where the quenching start temperature is less than 600° C., or when the average cooling rate during rapid cooling is less than 50° C/sec, ferrites precipitate and the martensite single-phase structure is difficult to obtain. The quenching start temperature is preferably 650° C. or higher, but the preferred upper limit is 950° C. or less. The average cooling rate during rapid cooling is preferably 70° C./sec or higher, but may be 100° C./sec or less.

After cooling to the room temperature, the steel sheet may be tempered by reheating to a temperature range of 350° C. or lower, preferably 300° C. or lower, and holding for 30 sec or longer in this temperature range to ensure the toughness. Where the tempering temperature is higher than 350° C., bending ability is degraded and the strength is difficult to ensure. Where the holding time is less than 30 sec, the toughness of the steel sheet is difficult to ensure. The holding time is preferably 100 sec or longer, more preferably 200 sec or longer, but where the holding time is too long, the martensite structure is softened and the strength decreases. Therefore, it is preferred that the holding time be 400 sec or less. In order to exhibit the tempering effect, it is preferred that the tempering temperature be 150° C. or higher, more preferably 200° C. or higher.

After the tempering, the correction is performed with a leveler. The elongation rate at the time of correction is preferably 0.5% or more. By performing such a correction, it is possible to obtain the KAM value specified by the present invention. The elongation rate when performing the correction with a leveler is more preferably 0.6% or more, even more preferably 0.7% or more. Where the elongation rate becomes too large, bending ability is degraded. Therefore, the elongation rate of 1.8% or less is preferred. The elongation rate, as referred to herein, is a value determined by the following Formula (2):

Elongation rate (%)=[(V₀−Vᵢ)/Vᵢ]×100 (2)

where V₀ is the speed of the passing sheet at the leveler outlet (units: m/sec), Vᵢ is the speed of the passing sheet at the leveler inlet (units: m/sec).

The steel sheet in accordance with the present invention includes not only of cold-rolled steels, but also of hot-rolled steel sheets. It also includes hot-dip galvanized steel sheets obtained by hot-dip galvanizing the hot-rolled steels or cold-rolled steel sheets, hot-dip galvanized and alloyed steel sheets obtained by performing the alloying treatment after the hot-dip galvanization, and electrogalvanized steel sheets. The galvanization increases corrosion resistance. The galvanization and allying treatment can be performed under the generally used conditions.

The high-strength steel sheet in accordance with the present invention can be used for producing high-strength parts for automobiles, such as bumpers.

The present invention will be explained hereinbelow in greater detail with reference to examples thereof, but it goes without saying that the present invention is not limited to the below-described examples and can be implemented with appropriate modifications within the ranges complying with the above- and below-described objectives, and all such modification are included in the technical scope of the present invention.

The present application claims priority to Japanese Patent Application No. 2014-004405 filed on Jan. 14, 2014. The entire contents of the specification of Japanese Patent Application No. 2014-004405 filed on Jan. 14, 2014, is incorporated herein by reference.

### EXAMPLES

Steel types A to V with chemical compositions presented in Table 1 were melted. More specifically, after primary refining in a converter, desulfurization was performed in a ladle. The balance in the chemical compositions presented in Table 1 is iron and inevitable impurities. Where necessary, vacuum degassing, for example, by an RH method (Ruhrstahl-Hausen method) was performed after the ladle refining. A slab was then obtained by continuous case performed by the usual method. The slab was successively hot rolled, pickled by the usual method, and cold rolled to obtain a cold-rolled steel sheet CR with a thickness of 1.0 mm. Each cold-rolled steel sheet CR was then continuously annealing. In the continuous annealing, the steel sheet was held at an annealing temperature and for an annealing time shown in Tables 2 and 3, then cooled at an average cooling rate of 10° C/sec to a quenching start temperature shown in Tables 2 and 3 below, then rapidly cooled at an average cooling rate of 50° C/sec or higher from the quenching start temperature to room temperature, then reheated to a tempering temperature shown in Tables 2 and 3 below, and held for a tempering time shown in Tables 2 and 3 at this temperature. The conditions of the hot rolling are presented below. The series of heat-treatment operation including the quenching and tempering is simply referred to hereinbelow also as “annealing treatment”.

Hot rolling conditions:

Heating temperature: 1250° C.;

Finish rolling temperature: 880° C.;

Coiling temperature: 700° C.;

Final thickness: 2.3 mm to 2.8 mm.

TABLE 1

| | | | | | | | | | | | | | | | | Ac₃ |
|---|---|---|---|---|---|---|---|---|---|---|---|---|---|---|---|---|
| Steel | Chemical composition (mass %) [balance: iron and inevitable impurities] | | | | | | | | | | | | | | | transformation |
| type | C | Si | Mn | P | S | Al | N | Cr | B | Cu | Ni | Ti | V | Nb | Ca | point (° C.) |
| A | 0.123 | 0.004 | 1.45 | 0.019 | 0.0018 | 0.022 | 0.0095 | — | — | — | — | — | — | — | — | 818 |
| B | 0.214 | 0.230 | 1.12 | 0.005 | 0.0098 | 0.145 | 0.0053 | — | — | — | — | — | — | — | — | 854 |
| C | 0.287 | 0.120 | 0.81 | 0.011 | 0.0054 | 0.075 | 0.0043 | — | — | — | — | — | — | — | — | 820 |
| D | 0.389 | 0.560 | 0.14 | 0.006 | 0.0024 | 0.041 | 0.0024 | — | — | — | — | — | — | — | — | 825 |
| E | 0.139 | 0.310 | 0.32 | 0.008 | 0.0034 | 0.039 | 0.0043 | 0.95 | — | — | — | — | — | — | — | 849 |
| F | 0.156 | 0.015 | 1.46 | 0.004 | 0.0018 | 0.121 | 0.0034 | — | 0.0098 | — | — | — | — | — | — | 838 |
| G | 0.357 | 0.150 | 0.45 | 0.012 | 0.0066 | 0.041 | 0.0087 | 0.31 | 0.0034 | — | — | — | — | — | — | 803 |
| H | 0.326 | 0.012 | 0.56 | 0.004 | 0.0023 | 0.043 | 0.0034 | — | — | 0.48 | — | — | — | — | — | 788 |
| I | 0.289 | 0.021 | 1.02 | 0.005 | 0.0043 | 0.054 | 0.0054 | — | — | — | 0.50 | — | — | — | — | 789 |
| J | 0.392 | 0.210 | 0.31 | 0.006 | 0.0025 | 0.075 | 0.0065 | — | — | 0.20 | 0.20 | — | — | — | — | 810 |
| K | 0.248 | 0.011 | 0.79 | 0.007 | 0.0016 | 0.046 | 0.0043 | 0.12 | 0.0017 | 0.10 | 0.10 | — | — | — | — | 804 |
| L | 0.172 | 0.410 | 1.48 | 0.004 | 0.0032 | 0.089 | 0.0054 | — | — | — | — | 0.196 | — | — | — | 917 |
| M | 0.292 | 0.032 | 1.02 | 0.005 | 0.0023 | 0.053 | 0.0044 | — | — | — | — | — | 0.1 | — | — | 806 |
| N | 0.213 | 0.012 | 1.42 | 0.006 | 0.0024 | 0.034 | 0.0064 | — | — | — | — | — | — | 0.1 | — | 792 |
| O | 0.176 | 0.021 | 1.29 | 0.007 | 0.0019 | 0.045 | 0.0048 | — | — | — | — | — | — | — | 0.0045 | 810 |
| P | 0.124 | 0.015 | 1.38 | 0.008 | 0.0035 | 0.064 | 0.0034 | — | — | — | — | 0.12 | 0.05 | 0.05 | 0.0021 | 882 |
| Q | 0.213 | 0.005 | 1.41 | 0.005 | 0.0023 | 0.063 | 0.0075 | 0.25 | 0.0021 | — | — | 0.05 | 0.05 | 0.05 | 0.0017 | 825 |
| R | 0.362 | 0.080 | 0.61 | 0.006 | 0.0018 | 0.046 | 0.0052 | — | — | 0.15 | 0.25 | 0.07 | 0.04 | 0.04 | 0.0024 | 821 |
| S | 0.230 | 0.004 | 0.99 | 0.004 | 0.0015 | 0.069 | 0.0049 | 0.07 | 0.0017 | 0.11 | 0.10 | 0.047 | — | — | — | 828 |
| T | 0.314 | 0.006 | 0.91 | 0.004 | 0.0021 | 0.074 | 0.0047 | 0.50 | 0.0013 | 0.21 | 0.10 | 0.03 | 0.1 | 0.1 | 0.0032 | 813 |
| U | 0.382 | 0.043 | 1.61 | 0.013 | 0.0049 | 0.056 | 0.0056 | — | — | — | — | — | — | — | — | 770 |
| V | 0.283 | 0.045 | 1.02 | 0.014 | 0.0053 | 0.043 | 0.0064 | 1.1 | — | — | — | — | — | — | — | 788 |

After the annealing treatment, the correction was performed with a leveler. The conditions of the leveler correction are presented hereinbelow. “WR” hereinbelow means a work roll. As depicted in Tables 2 and 3, a cold-rolled steel sheet CR which has not been subjected to leveler correction after the annealing treatment and a cold-rolled steel sheet CR which was subjected to correction by skin pass rolling instead of the leveler correction were also produced.

Conditions of leveler correction:

WR diameter=50 mm;

WR arrangement: 9 on upper side and 10 on underside;

WR pitch=55 mm.

Intermeshing: inlet=-3.74 mm, outlet=-1.18 mm; Tension: inlet=1.0 kgf/mm² to 1.7 kgf/mm² (9.8 MPa to 16.7 MPa), outlet=2.0 kgf/mm² to 2.3 kgf/mm² (19.6 MPa to 22.5 MPa).

TABLE 2

| | | Annealing | | Quenching start | Tempering | | | | Elongation | |
|---|---|---|---|---|---|---|---|---|---|---|
| Test | Steel | temperature | Annealing | temperature | temperature | Tempering | | Correction | rate | |
| No. | type | (° C.) | time (sec) | (° C.) | (° C.) | time (sec) | Structure | method | (%) | Note |
| 1 | A | 945 | 90 | 750 | 200 | 360 | Martensite 100% | Leveler | 1.0 | Example |
| 2 | | 945 | 90 | 750 | 200 | 360 | Martensite 100% | Skin pass | 1.0 | Compar. |
| | | | | | | | | rolling | | Example |
| 3 | | 945 | 90 | 750 | 200 | 360 | Martensite 100% | None | — | Compar. |
| | | | | | | | | | | Example |
| 4 | B | 920 | 60 | 660 | 250 | 360 | Martensite 98%, ferrite 2% | Leveler | 1.0 | Example |
| 5 | | 920 | 60 | 660 | 250 | 360 | Martensite 98%, ferrite 2% | None | — | Compar. |
| | | | | | | | | | | Example |
| 6 | C | 840 | 120 | 640 | 300 | 360 | Martensite 96%, ferrite 4% | Leveler | 1.0 | Example |
| 7 | | 840 | 120 | 640 | 300 | 360 | Martensite 96%, ferrite 4% | Skin pass | 1.0 | Compar. |
| | | | | | | | | rolling | | Example |
| 8 | | 840 | 120 | 640 | 300 | 360 | Martensite 96%, ferrite 4% | None | — | Compar. |
| | | | | | | | | | | Example |
| 9 | D | 900 | 120 | 650 | 350 | 360 | Martensite 94%, ferrite 6% | Leveler | 1.0 | Example |
| 10 | | 900 | 120 | 650 | 350 | 360 | Martensite 94%, ferrite 6% | None | — | Compar. |
| | | | | | | | | | | Example |
| 11 | E | 920 | 120 | 700 | 240 | 30 | Martensite 100% | Leveler | 0.8 | Example |
| 12 | | 920 | 120 | 700 | 240 | 30 | Martensite 100% | None | — | Compar. |
| | | | | | | | | | | Example |
| 13 | F | 900 | 120 | 700 | 220 | 360 | Martensite 100% | Leveler | 0.8 | Example |
| 14 | | 900 | 120 | 700 | 220 | 360 | Martensite 100% | None | — | Compar. |
| | | | | | | | | | | Example |
| 15 | G | 900 | 120 | 670 | 350 | 360 | Martensite 100% | Leveler | 0.8 | Example |
| 16 | | 900 | 120 | 670 | 350 | 360 | Martensite 100% | Skin pass | 0.8 | Compar. |
| | | | | | | | | rolling | | Example |
| 17 | | 900 | 120 | 670 | 350 | 360 | Martensite 100% | None | — | Compar. |
| | | | | | | | | | | Example |
| 18 | H | 900 | 60 | 700 | 210 | 360 | Martensite 100% | Leveler | 0.8 | Example |
| 19 | | 900 | 60 | 700 | 210 | 360 | Martensite 100% | None | — | Compar. |
| | | | | | | | | | | Example |
| 20 | I | 900 | 60 | 700 | 190 | 180 | Martensite 100% | Leveler | 1.0 | Example |
| 21 | | 900 | 60 | 700 | 190 | 180 | Martensite 100% | Skin pass | 1.0 | Compar. |
| | | | | | | | | rolling | | Example |
| 22 | | 900 | 60 | 700 | 190 | 180 | Martensite 100% | None | — | Compar. |
| | | | | | | | | | | Example |
| 23 | J | 880 | 120 | 700 | 190 | 360 | Martensite 100% | Leveler | 1.0 | Example |
| 24 | | 880 | 120 | 700 | 190 | 360 | Martensite 100% | None | — | Compar. |
| | | | | | | | | | | Example |
| 25 | K | 860 | 90 | 650 | 230 | 360 | Martensite 99%, ferrite 1% | Leveler | 1.0 | Example |
| 26 | | 860 | 90 | 650 | 230 | 360 | Martensite 99%, ferrite 1% | None | — | Compar. |
| | | | | | | | | | | Example |

TABLE 3

| | | Annealing | | Quenching start | Tempering | | | | Elongation | |
|---|---|---|---|---|---|---|---|---|---|---|
| Test | Steel | temperature | Annealing | temperature | temperature | Tempering | | Correction | rate | |
| No. | type | (° C.) | time (sec) | (° C.) | (° C.) | time (sec) | Structure | method | (%) | Note |
| 27 | L | 940 | 90 | 700 | 190 | 360 | Martensite 100% | Leveler | 0.8 | Example |
| 28 | | 940 | 90 | 700 | 190 | 360 | Martensite 100% | Skin pass | 0.8 | Compar. |
| | | | | | | | | rolling | | Example |
| 29 | | 940 | 90 | 700 | 190 | 360 | Martensite 100% | None | — | Compar. |
| | | | | | | | | | | Example |
| 30 | M | 900 | 120 | 700 | 280 | 360 | Martensite 100% | Leveler | 1.2 | Example |
| 31 | | 900 | 120 | 700 | 280 | 360 | Martensite 100% | None | — | Compar. |
| | | | | | | | | | | Example |
| 32 | N | 900 | 120 | 870 | 240 | 360 | Martensite 100% | Leveler | 0.6 | Example |
| 33 | | 900 | 120 | 870 | 240 | 360 | Martensite 100% | None | — | Compar. |
| | | | | | | | | | | Example |
| 34 | O | 900 | 90 | 700 | 260 | 120 | Martensite 100% | Leveler | 1.0 | Example |
| 35 | | 900 | 90 | 700 | 260 | 120 | Martensite 100% | Skin pass | 1.0 | Compar. |
| | | | | | | | | rolling | | Example |
| 36 | | 900 | 90 | 700 | 260 | 120 | Martensite 100% | None | — | Compar. |
| | | | | | | | | | | Example |
| 37 | P | 930 | 60 | 700 | 160 | 360 | Martensite 100% | Leveler | 0.8 | Example |
| 38 | | 930 | 60 | 700 | 160 | 360 | Martensite 100% | None | — | Compar. |
| | | | | | | | | | | Example |
| 39 | Q | 850 | 120 | 600 | 200 | 360 | Martensite 100% | Leveler | 0.8 | Example |
| 40 | | 850 | 120 | 600 | 200 | 360 | Martensite 100% | None | — | Compar. |
| | | | | | | | | | | Example |
| 41 | R | 900 | 120 | 700 | 230 | 240 | Martensite 100% | Leveler | 0.6 | Example |
| 42 | | 900 | 120 | 700 | 230 | 240 | Martensite 100% | Skin pass | 0.6 | Compar. |
| | | | | | | | | rolling | | Example |
| 43 | | 900 | 120 | 700 | 230 | 240 | Martensite 100% | None | — | Compar. |
| | | | | | | | | | | Example |
| 44 | S | 940 | 30 | 650 | 160 | 360 | Martensite 95%, ferrite 5% | Leveler | 1.0 | Example |
| 45 | | 940 | 30 | 650 | 160 | 360 | Martensite 95%, ferrite 5% | Skin pass | 1.0 | Compar. |
| | | | | | | | | rolling | | Example |
| 46 | | 940 | 30 | 650 | 160 | 360 | Martensite 95%, ferrite 5% | None | — | Compar. |
| | | | | | | | | | | Example |
| 47 | T | 900 | 120 | 900 | 200 | 60 | Martensite 100% | Leveler | 0.8 | Example |
| 48 | | 900 | 120 | 900 | 200 | 60 | Martensite 100% | None | — | Compar. |
| | | | | | | | | | | Example |
| 49 | U | 900 | 120 | 700 | 200 | 360 | Martensite 100% | Leveler | 1.0 | Compar. |
| | | | | | | | | | | Example |
| 50 | | 900 | 120 | 700 | 200 | 360 | Martensite 100% | None | — | Compar. |
| | | | | | | | | | | Example |
| 51 | V | 900 | 120 | 700 | 200 | 360 | Martensite 100% | Leveler | 0.8 | Compar. |
| | | | | | | | | | | Example |
| 52 | | 900 | 120 | 700 | 200 | 360 | Martensite 100% | None | — | Compar. |
| | | | | | | | | | | Example |

Various properties were evaluated under the below-described conditions by using the cold-rolled steel sheets CR subjected to the above-described treatment.

Measurement of Surface Areas of Steel Structures

A cross section paralleled to the rolling direction of a 1.0 mm×20 mm×20 mm testpiece was polished and subjected to Nital corrosion. A portion of ¼ the sheet thickness was then observed under a scanning electron microscope (SEM) under a magnification of 1000.

The size of a single field of view was taken as 90 μm×120 μn, 10 horizontal and 10 vertical lines were drawn equidistantly in 10 random fields of view, and the area ratio of the martensite structure and the area ratio of the non-martensite structure, for example, ferrite structure, were determined by dividing the number of intersections in the martensite structure and the number of intersections in the non-martensite structure by the total number of intersections. The results are presented in Tables 2 and 3 together with the correction method ((a) correction with a leveler or by skin pass rolling; (b) no correction) and elongation rate at the time of correction.

Evaluation of Tensile Properties

A tensile testpiece JIS5 was sampled from the steel sheet such that the direction perpendicular to the rolling direction was the longitudinal direction, and the tensile strength TS was measured by the method stipulated by JIS Z2241:2011. The tensile strength TS of 1180 MPa or higher was evaluated as a high strength. The results are shown in Tables 4 and 5. In Tables 4 and 5, the yield strength YP (Yield Point) and elongation E1 were also shown for reference.

Measurement of KAM Value

A sample was obtained by mechanically grinding to a position of ½ the sheet thickness and then buffing to obtain a mirror finished surface. An electron backscatter diffraction image of a 100 μm×100 μm region was measured by SEM with a step of 0.25 as the pitch of measurement points in a state in which the sample was inclined by 70°, an OTM system of TexSEM Laboratories, Inc. was used as the analytical software, a KAM value in each measurement point was determined, and the ratio of the regions in which the KAM value is 1° or more, that is, the ratio of the measurement points in which the KAM value is 1° or more to the total number of measurement points, was calculated.

Measurement of the maximum residual tensile stress in a surface layer region from a surface to a position at a depth of ¼ the sheet thickness: successive thickness removal method

Each cold-rolled steel sheet CR was cut by shearing to a size of 60 mm in the direction perpendicular to the rolling direction, a size of 10 mm in the rolling direction, and a thickness of 1.0 mm, a strain gage was attached to the central portion on one side of the steel sheet, that is, on the side opposite that of the corrosion surface, so as to be parallel to the direction perpendicular to the rolling direction, and the entire surface outside the corrosion surface was coated with a Furuto Mask. The lead wires of the strain gage were also coated with the Furuto Mask. The testpiece was then treated with a corrosive liquid, and the sheet thickness was gradually reduced. The strains released in this process were measured every 5 min.

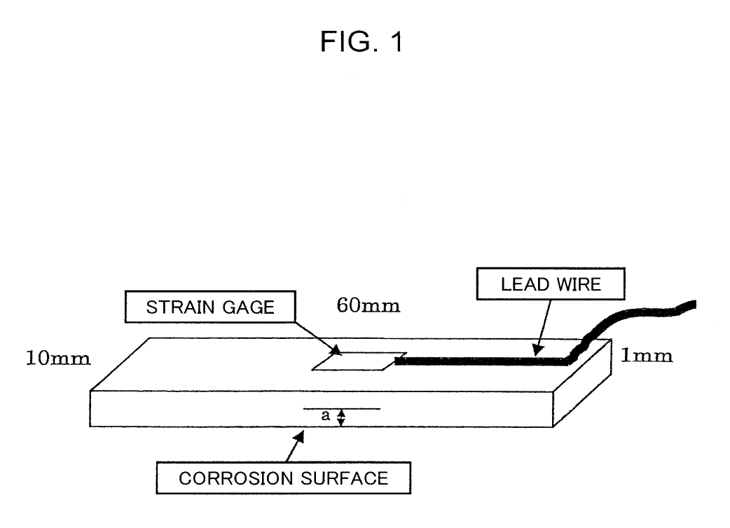

The corrosion rate was calculated from the corrosion reduction amount in 15-h corrosion, and the position of the sheet thickness at which the strain amount was measured was calculated from the corrosion rate and corrosion time. The residual stress was calculated from the following theoretical formula. For the theoretical formula, see, for example, “Occurrence of Residual Stresses and Measures Thereagainst, 1975, Shigeru Yonetani, p. 54, Formula (17)”. The maximum value of the residual stress in the polynomial curve approximation of changes in the residual stress in a region from the surface to the position at ¼ of the sheet thickness (the largest R2 square values in the second to sixth orders (second-order function to six-order function) were used) was taken as the maximum residual tensile stress. The state of the testpiece during the measurements of the residual tensile stress of the steel sheet is shown in the schematic perspective view in FIG. 1.

Strain gage: FLK-6-11-2LT (Tokyo Kikai Seisakusho).

Coating material: Furuto Mask (the entire surface outside the corrosion surface is coated).

Corrosive liquid: water 750 mL, HF 37.5 mL, H₂O₂ 750 mL.

Corrosion method: corrosion for 15 h while agitating the corrosive liquid with a magnetic stirrer at all times. The temperature was controlled by placing the container with the corrosive liquid into iced water so at to maintain a constant temperature within a temperature range of 10° C. to 20° C.

$$σ ( a ) = - \frac{E}{2} \{ ( h - a ) \frac{d ɛ}{d a} - 4 ɛ + 6 ( h - a ) {\int }_{0}^{a} \frac{ɛ}{{( h - x )}^{2}} d x \} \qquad [ Math . Formula 1 ]$$

where a is the residual tensile stress, a is the measurement position, E is the Young's modulus of iron, h is the sheet thickness, ε is the strain amount, x is the variable representing the position from the sheet surface before the corrosion to the measurement position.

The following property evaluation was likewise performed with respect to electrogalvanized steel sheets EG (Electro Galvanizing steel sheets) obtained by electrogalvanizing the surface of the cold-rolled steel sheets CR. The electrogalvanized steel sheets EG were produced by electrogalvanizing the cold-rolled steel sheets CR after the annealing treatment and leveler correction, but they may be also produced by electrogalvanizing the cold-rolled steel sheets CR subjected to the annealing treatment and then performing the leveler correction. When the hot-dip galvanized steel sheet or hot-dip galvanized and alloyed steel sheet is produced, the annealing treatment is performed in the hot-dip galvanization line. Therefore, the leveler correction may be performed after producing the hot-dip galvanized steel sheet or hot-dip galvanized and alloyed steel sheet in the hot-dip galvanization line.

Production of Electrogalvanized Steel Sheet EG

An electrogalvanized steel sheet EG was obtained by dipping the cold-rolled steel sheet CR into a zinc plating bath at 60° C., electrogalvanizing at a current density of 40 A/dm², and when washing with water and drying.

Cutting conditions for a testpiece for evaluating the resistance to delayed fracture of the cutting end surface

The cold-rolled steel sheets CR after the annealing treatment and leveler correction and the electrogalvanized steel sheets EG produced in the above-described manner were cut with a shear cutting machine to a size of 40 mm in the direction perpendicular to the rolling direction and a size of 30 mm in the rolling direction to obtain testpieces. The cutting clearance was 10%.

Measurement of the Number of Cracks Introduced During Cutting

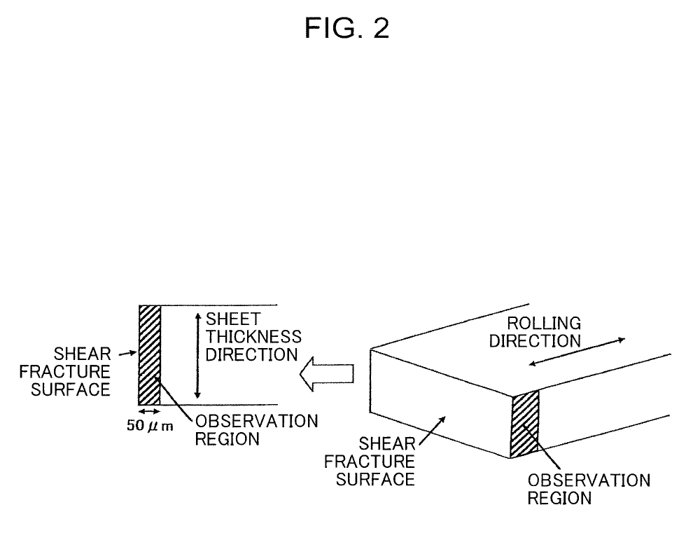

The end surface in the direction perpendicular to the rolling direction of the cut testpiece was polished and subjected to Nital corrosion in order to observe the cross section up to 50 μm from the cut end surface. The entire region in the sheet thickness direction in the side cross section up to 50 μm from the cut end surface (also referred to as “shear fracture surface”) was observed with a SEM under a magnification of 3000, and the number of cracks of 2 μm or more was measured. The average value for n=3 was taken as the measurement value. The observation region during the measurement of the number of cracks introduced during curing is shown schematically in FIG. 2.

Test for Evaluation of Resistance to Delayed Fracture of the Cut End Surface

The cut testpieces were immersed for 24 h in 0.1N 5% or 10% hydrochloric acid. A total of n=3 of testpieces were immersed for each condition, and only the end surface perpendicular to the rolling direction was evaluated. Since each testpiece had two end surfaces, n=6 evaluations were performed with respect to one condition of hydrochloric acid immersion. In the evaluation, the cut end surface was observed with a naked eye or under a microscope, it was assumed that the delayed fracture did not occur when no cracks of 200 μm or more were initiated, and the delayed fracture non-occurrence ratio of the cut end surface [=(delayed fracture non-occurrence testpieces)/(total number of testpieces)×100] was calculated).

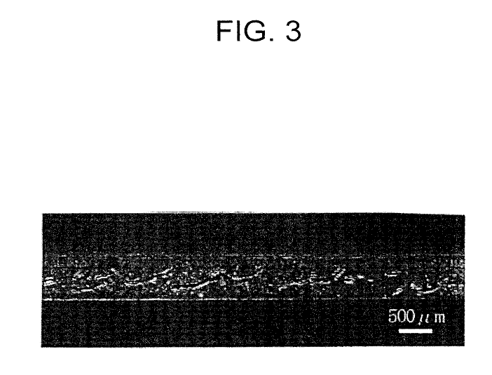

The cold-rolled steel sheets CR with the delayed fracture non-occurrence ratio of the cut end surface of 44% or more and the electrogalvanized steel sheets EG with the delayed fracture non-occurrence ratio of the cut end surface of 33% or more were determined to have good resistance to delayed fracture of the cut end surface and were represented by “O. K” in the “Evaluation” column in Tables 4 to 7 hereinbelow. The testpieces for which the delayed fracture non-occurrence ratio of the cut end surface did not meet the aforementioned requirements were determined to have poor resistance to delayed fracture of the cut end surface and were represented by “N. G” in the “Evaluation” column in Tables 4 to 7 hereinbelow. An example of cracks induced by delayed fracture in the cut end surface is shown in the photo in FIG. 3.

Production of Testpiece for Evaluation of Resistance to Delayed Fracture of the Steel Sheet Base Material

The annealed steel sheet was cut with a clearance of 10% by using a shear cutting machine to a size of 150 mm in the direction perpendicular to the rolling direction and a size of 30 mm in the rolling direction, and stress loading similar to the TS was performed by U bending with a bending radius R of 10 mm.

Test for Evaluation of Resistance to Delayed Fracture of the Steel Sheet Base Material

The testpieces subjected to the U-bending—stress loading were immersed for 200 h in 0.1N 5% or 10% hydrochloric acid. The testpieces were immersed n=18 times for each condition. It was assumed that the delayed fracture did not occur when no cracks were initiated, and the delayed fracture non-occurrence ratio of the steel sheet base material [=(delayed fracture non-occurrence testpieces)/(total number of testpieces)×100] was calculated. In order to evaluate the resistance to delayed fracture of the steel sheet base material which is created by the correction means, the difference in the delayed fracture non-occurrence ratio with the case “without correction” was calculated. The testpieces for which the difference in the delayed fracture non-occurrence ratio was 10% or less were determined to have good resistance to delayed fracture of the steel sheet base material and were represented by “O. K” in the “Evaluation” column in Tables 4 to 7 hereinbelow. The testpieces for which the aforementioned criterion was not met were determined to have poor resistance to delayed fracture of the cut end surface and were represented by “N. G” in the “Evaluation” column in Tables 4 to 7 hereinbelow.

In order to evaluate the resistance to delayed fracture corresponding to the TS level, the product of (delayed fracture non-occurrence ratio of the cut end surface)×TS was also calculated as an indicator for evaluation. The testpieces of the cold-rolled steel sheets CR for which the product of (delayed fracture non-occurrence ratio of the cut end surface)×TS was 60,000 or more, and the testpieces of the electrogalvanized steel sheets EG for which the product of (delayed fracture non-occurrence ratio of the cut end surface)×TS was 48,000 or more were determined to have good resistance to delayed fracture of the steel sheet base material and were represented by “O. K” in the “Evaluation” column in Tables 4 to 7 hereinbelow. The testpieces for which the product of (delayed fracture non-occurrence ratio of the cut end surface)×TS did not meet the aforementioned criterion were determined to have poor resistance to delayed fracture of the cut end surface and were represented by “N. G” in the “Evaluation” column in Tables 4 to 7 hereinbelow.

The rating criterion for the product of (delayed fracture non-occurrence ratio of the cut end surface)×TS differs between the cold-rolled steel sheets CR and electrogalvanized steel sheets EG for the following reason. Thus, in the electrogalvanized steel sheet EG, since the plated layer melts during the fracture evaluation, the amount of hydrogen penetrating into the steel sheet due to corrosion is larger than in the cold-rolled steel sheet CR, and the resistance to delayed fracture decreases. Accordingly, the rating criterion for the electrogalvanized steel sheets EG was set lower with consideration for the decrease in resistance to delayed fracture caused by the attachment of the plated layer.

The evaluation results are shown in Tables 4 to 7 hereinbelow. Tables 4 and 5 show the evaluation results for which the steel type is the cold-rolled steel sheet CR, and Tables 6 and 7 show the evaluation results for which the steel type is the electrogalvanized steel sheet EG.

TABLE 4

| | | | | | | Maximum tensile | | | | | | | | | | |
|---|---|---|---|---|---|---|---|---|---|---|---|---|---|---|---|---|
| | | | | | | residual stress in | | | | | | | | | | |
| | | | | | | surface layer region | | | | | | | | | | |
| | | | | | | up to depth of ¼ of | | Difference in | | | | Delayed | | Delayed | | |
| | | | | | | sheet thickness from | Delayed fracture | delayed fracture | | | Number of | fracture | | fracture | | |
| | | | | | | surface (MPa) | non-occurrence | non-occurrence | | Ratio of | cracks | non-occurrence | | non-occurrence | | |
| | | | | | | *-indicates | ratio of steel | ratios in steel | | KAM | introduced | ratio in cut | | ratio in cut end | | |
| Test | Steel | Product | YP | TS | EL | compressive residual | sheet base | sheet base | | value | during | end surface | | surface × TS | | |
| No. | type | type | (MPa) | (MPa) | (%) | stress | material (%) | material (%) | Evaluation | ≧1 (%) | cutting | (%) | Evaluation | (% · MPa) | Evaluation | Notes |
| 1 | A | CR | 1067 | 1231 | 6.6 | 0 | 67 | 0 | O.K | 70 | 44 | 72 | O.K | 88906 | O.K | Example |
| 2 | | | 1062 | 1234 | 6.5 | 98 | 33 | 34 | N.G | 71 | 45 | 72 | O.K | 89122 | O.K | Compar. |
| | | | | | | | | | | | | | | | | Example |
| 3 | | | 1002 | 1198 | 7.5 | 45 | 67 | 0 | O.K | 47 | 82 | 50 | O.K | 59900 | N.G | Compar. |
| | | | | | | | | | | | | | | | | Example |
| 4 | B | | 1301 | 1475 | 5.6 | 9 | 33 | 0 | O.K | 63 | 54 | 50 | O.K | 73750 | O.K | Example |
| 5 | | | 1247 | 1453 | 6.5 | 43 | 33 | 0 | O.K | 42 | 90 | 33 | N.G | 48433 | N.G | Compar. |
| | | | | | | | | | | | | | | | | Example |
| 6 | C | | 1347 | 1475 | 5.9 | 3 | 33 | 0 | O.K | 65 | 48 | 50 | O.K | 73750 | O.K | Example |
| 7 | | | 1339 | 1471 | 5.9 | 103 | 11 | 22 | N.G | 66 | 49 | 50 | O.K | 73550 | O.K | Compar. |
| | | | | | | | | | | | | | | | | Example |
| 8 | | | 1301 | 1464 | 6.9 | 47 | 33 | 0 | O.K | 38 | 87 | 33 | N.G | 48800 | N.G | Compar. |
| | | | | | | | | | | | | | | | | Example |
| 9 | D | | 1421 | 1542 | 6.2 | 8 | 33 | 0 | O.K | 64 | 49 | 44 | O.K | 68533 | O.K | Example |
| 10 | | | 1377 | 1530 | 7.2 | 53 | 33 | 0 | O.K | 40 | 89 | 33 | N.G | 51000 | N.G | Compar. |
| | | | | | | | | | | | | | | | | Example |
| 11 | E | | 1043 | 1254 | 5.0 | 14 | 67 | 0 | O.K | 65 | 50 | 67 | O.K | 83600 | O.K | Example |
| 12 | | | 1001 | 1236 | 5.9 | 35 | 67 | 0 | O.K | 45 | 85 | 44 | O.K | 54933 | x | Compar. |
| | | | | | | | | | | | | | | | | Example |
| 13 | F | | 1146 | 1336 | 5.3 | 16 | 67 | 0 | O.K | 67 | 51 | 50 | O.K | 66800 | O.K | Example |
| 14 | F | | 1095 | 1310 | 6.1 | 34 | 67 | 0 | O.K | 42 | 90 | 33 | N.G | 43667 | N.G | Compar. |
| | | | | | | | | | | | | | | | | Example |
| 15 | G | | 1356 | 1489 | 4.4 | 17 | 33 | 0 | O.K | 68 | 48 | 50 | O.K | 74450 | O.K | Example |
| 16 | | | 1349 | 1482 | 4.5 | 87 | 11 | 22 | N.G | 64 | 50 | 44 | O.K | 65867 | O.K | Compar. |
| | | | | | | | | | | | | | | | | Example |
| 17 | | | 1312 | 1471 | 5.2 | 48 | 33 | 0 | N.G | 45 | 87 | 28 | N.G | 40861 | N.G | Compar. |
| | | | | | | | | | | | | | | | | Example |
| 18 | H | | 1419 | 1785 | 5.0 | 21 | 33 | 0 | O.K | 73 | 39 | 67 | O.K | 119000 | O.K | Example |
| 19 | | | 1371 | 1771 | 5.8 | 41 | 33 | 0 | O.K | 49 | 75 | 50 | O.K | 88550 | O.K | Compar. |
| | | | | | | | | | | | | | | | | Example |
| 20 | I | | 1375 | 1667 | 4.6 | 15 | 33 | 0 | O.K | 67 | 48 | 67 | O.K | 111133 | O.K | Example |
| 21 | | | 1365 | 1659 | 4.6 | 95 | 11 | 22 | N.G | 65 | 48 | 67 | O.K | 110600 | O.K | Compar. |
| | | | | | | | | | | | | | | | | Example |
| 22 | | | 1321 | 1645 | 5.6 | 36 | 33 | 0 | O.K | 45 | 88 | 50 | O.K | 82250 | O.K | Compar. |
| | | | | | | | | | | | | | | | | Example |
| 23 | J | | 1774 | 2021 | 4.5 | 8 | 33 | 0 | O.K | 75 | 38 | 50 | O.K | 101050 | O.K | Example |
| 24 | | | 1723 | 2011 | 5.5 | 32 | 33 | 0 | O.K | 47 | 84 | 33 | N.G | 67033 | O.K | Compar. |
| | | | | | | | | | | | | | | | | Example |
| 25 | K | | 1432 | 1664 | 4.9 | 12 | 67 | 0 | O.K | 62 | 56 | 50 | O.K | 83200 | O.K | Example |
| 26 | | | 1372 | 1652 | 5.8 | 38 | 67 | 0 | O.K | 42 | 90 | 39 | N.G | 64244 | O.K | Compar. |
| | | | | | | | | | | | | | | | | Example |

TABLE 5

| | | | | | | Maximum tensile | | | | | | | | | | |
|---|---|---|---|---|---|---|---|---|---|---|---|---|---|---|---|---|
| | | | | | | residual stress in | | | | | | | | | | |
| | | | | | | surface layer region | | | | | | | | | | |
| | | | | | | up to depth of ¼ of | | Difference in | | | | Delayed | | Delayed | | |
| | | | | | | sheet thickness from | Delayed fracture | delayed fracture | | | Number of | fracture | | fracture | | |
| | | | | | | surface (MPa) | non-occurrence | non-occurrence | | Ratio of | cracks | non-occurrence | | non-occurrence | | |
| | | | | | | *-indicates | ratio of steel | ratios in steel | | KAM | introduced | ratio in cut | | ratio in cut end | | |
| Test | Steel | Product | YP | TS | EL | compressive residual | sheet base | sheet base | | value | during | end surface | | surface × TS | | |
| No. | type | type | (MPa) | (MPa) | (%) | stress | material (%) | material (%) | Evaluation | ≧1 (%) | cutting | (%) | Evaluation | (% · MPa) | Evaluation | Notes |
| 27 | L | CR | 1248 | 1498 | 4.7 | 7 | 67 | 0 | O.K | 65 | 51 | 50 | O.K | 74900 | O.K | Example |
| 28 | | | 1251 | 1493 | 4.8 | 91 | 44 | 23 | N.G | 67 | 49 | 50 | O.K | 74650 | O.K | Compar. |
| | | | | | | | | | | | | | | | | Example |
| 29 | | | 1213 | 1470 | 5.5 | 46 | 67 | 0 | O.K | 46 | 83 | 33 | N.G | 49000 | N.G | Compar. |
| | | | | | | | | | | | | | | | | Example |
| 30 | M | | 1395 | 1523 | 4.8 | −11 | 78 | −11 | O.K | 70 | 44 | 44 | O.K | 67689 | O.K | Example |
| 31 | | | 1356 | 1501 | 5.6 | 43 | 67 | 0 | O.K | 48 | 82 | 33 | N.G | 50033 | N.G | Compar. |
| | | | | | | | | | | | | | | | | Example |
| 32 | N | | 1254 | 1445 | 4.8 | 25 | 67 | 0 | O.K | 57 | 64 | 50 | O.K | 72250 | O.K | Example |
| 33 | | | 1210 | 1423 | 5.5 | 46 | 67 | 0 | O.K | 42 | 88 | 39 | N.G | 55339 | N.G | Compar. |
| | | | | | | | | | | | | | | | | Example |
| 34 | O | | 1179 | 1326 | 4.9 | −1 | 78 | −11 | O.K | 65 | 51 | 61 | O.K | 81033 | O.K | Example |
| 35 | | | 1182 | 1319 | 4.8 | 107 | 56 | 11 | N.G | 62 | 56 | 56 | O.K | 73278 | O.K | Compar. |
| | | | | | | | | | | | | | | | | Example |
| 36 | | | 1138 | 1311 | 5.8 | 38 | 67 | 0 | O.K | 42 | 90 | 44 | O.K | 58267 | N.G | Compar. |
| | | | | | | | | | | | | | | | | Example |
| 37 | P | | 1075 | 1245 | 5.4 | 11 | 100 | 0 | O.K | 71 | 43 | 67 | O.K | 83000 | O.K | Example |
| 38 | | | 1021 | 1228 | 6.2 | 51 | 100 | 0 | O.K | 44 | 85 | 50 | O.K | 61400 | O.K | Compar. |
| | | | | | | | | | | | | | | | | Example |
| 39 | Q | | 1301 | 1573 | 5.1 | 4 | 67 | 0 | O.K | 68 | 46 | 44 | O.K | 69911 | O.K | Example |
| 40 | | | 1253 | 1555 | 5.9 | 47 | 67 | 0 | O.K | 47 | 82 | 33 | N.G | 51833 | N.G | Compar. |
| | | | | | | | | | | | | | | | | Example |
| 41 | R | | 1583 | 1761 | 4.7 | 21 | 33 | 0 | O.K | 59 | 58 | 67 | O.K | 117400 | O.K | Example |
| 42 | | | 1540 | 1750 | 5.4 | 82 | 0 | 33 | N.G | 56 | 55 | 67 | O.K | 116667 | O.K | Compar. |
| | | | | | | | | | | | | | | | | Example |
| 43 | | | 1540 | 1750 | 5.4 | 43 | 33 | 0 | O.K | 38 | 94 | 44 | O.K | 77778 | O.K | Compar. |
| | | | | | | | | | | | | | | | | Example |
| 44 | S | | 1287 | 1558 | 6.3 | 10 | 67 | 0 | O.K | 72 | 40 | 50 | O.K | 77900 | O.K | Example |
| 45 | | | 1279 | 1552 | 6.4 | 102 | 33 | 23 | N.G | 67 | 45 | 44 | O.K | 68978 | O.K | Compar. |
| | | | | | | | | | | | | | | | | Example |
| 46 | | | 1220 | 1542 | 7.2 | 38 | 56 | 0 | O.K | 48 | 81 | 39 | N.G | 59967 | N.G | Compar. |
| | | | | | | | | | | | | | | | | Example |
| 47 | T | | 1495 | 1776 | 5.3 | 15 | 33 | 0 | O.K | 68 | 45 | 61 | O.K | 108533 | O.K | Example |
| 48 | | | 1459 | 1756 | 6.1 | 36 | 33 | 0 | O.K | 45 | 84 | 50 | O.K | 87800 | O.K | Compar. |
| | | | | | | | | | | | | | | | | Example |
| 49 | U | | 1773 | 2112 | 4.5 | −5 | 0 | 0 | O.K | 75 | 48 | 22 | N.G | 46933 | N.G | Compar. |
| | | | | | | | | | | | | | | | | Example |
| 50 | | | 1721 | 2090 | 5.5 | 45 | 0 | 0 | O.K | 49 | 92 | 17 | N.G | 34833 | N.G | Compar. |
| | | | | | | | | | | | | | | | | Example |
| 51 | V | | 1389 | 1686 | 4.7 | 2 | 0 | 0 | O.K | 72 | 45 | 28 | N.G | 46833 | N.G | Compar. |
| | | | | | | | | | | | | | | | | Example |
| 52 | | | 1351 | 1672 | 5.6 | 53 | 0 | 0 | O.K | 45 | 83 | 17 | N.G | 27867 | N.G | Compar. |
| | | | | | | | | | | | | | | | | Example |

TABLE 6

| | | | | | | Maximum | | | | | | | | | | |
|---|---|---|---|---|---|---|---|---|---|---|---|---|---|---|---|---|
| | | | | | | tensile residual | | | | | | | | | | |
| | | | | | | stress in | | | | | | | | | | |
| | | | | | | surface layer | | | | | | | | | | |
| | | | | | | region up to | | | | | | | | | | |
| | | | | | | depth of ¼ of | | | | | | | | | | |
| | | | | | | sheet thickness | Delayed | Difference in | | | | Delayed | | Delayed | | |
| | | | | | | from surface | fracture | delayed fracture | | Ratio | Number of | fracture | | fracture | | |
| | | | | | | (MPa) | non-occurrence | non-occurrence | | of | cracks | non-occurrence | | non-occurrence | | |
| | | | | | | *-indicates | ratio of steel | ratios in steel | | KAM | introduced | ratio in cut | | ratio in cut end | | |
| Test | Steel | Product | YP | TS | EL | compressive | sheet base | sheet base | | value | during | end surface | | surface × TS | | |
| No. | type | type | (MPa) | (MPa) | (%) | residual stress | material (%) | material (%) | Evaluation | ≧1 (%) | cutting | (%) | Evaluation | (% · MPa) | Evaluation | Notes |
| 53 | A | EG | 1067 | 1231 | 6.6 | 0 | 67 | 0 | O.K | 70 | 42 | 67 | O.K | 82067 | O.K | Example |
| 54 | | | 1062 | 1234 | 6.5 | 98 | 33 | 34 | N.G | 71 | 47 | 67 | O.K | 82267 | O.K | Compar. |
| | | | | | | | | | | | | | | | | Example |
| 55 | | | 1002 | 1198 | 7.5 | 45 | 67 | 0 | O.K | 47 | 78 | 39 | O.K | 46589 | N.G | Compar. |
| | | | | | | | | | | | | | | | | Example |
| 56 | B | | 1301 | 1475 | 5.6 | 9 | 33 | −11 | O.K | 63 | 55 | 33 | O.K | 49167 | O.K | Example |
| 57 | | | 1247 | 1453 | 6.5 | 43 | 22 | 0 | O.K | 42 | 89 | 17 | N.G | 24217 | N.G | Compar. |
| | | | | | | | | | | | | | | | | Example |
| 58 | C | | 1347 | 1475 | 5.9 | 3 | 33 | −11 | O.K | 65 | 45 | 33 | O.K | 49167 | O.K | Example |
| 59 | | | 1339 | 1471 | 5.9 | 103 | 11 | 11 | O.K | 66 | 48 | 33 | O.K | 49033 | O.K | Compar. |
| | | | | | | | | | | | | | | | | Example |
| 60 | | | 1301 | 1464 | 6.9 | 47 | 22 | 0 | O.K | 38 | 88 | 22 | N.G | 32533 | N.G | Compar. |
| | | | | | | | | | | | | | | | | Example |
| 61 | D | | 1421 | 1542 | 6.2 | 8 | 33 | −11 | O.K | 64 | 49 | 33 | O.K | 51400 | O.K | Example |
| 62 | | | 1377 | 1530 | 7.2 | 53 | 22 | 0 | O.K | 40 | 89 | 17 | N.G | 25500 | N.G | Compar. |
| | | | | | | | | | | | | | | | | Example |
| 63 | E | | 1043 | 1254 | 5.0 | 14 | 67 | 0 | O.K | 65 | 52 | 50 | O.K | 62700 | O.K | Example |
| 64 | | | 1001 | 1236 | 5.9 | 35 | 67 | 0 | O.K | 45 | 82 | 33 | O.K | 41200 | N.G | Compar. |
| | | | | | | | | | | | | | | | | Example |
| 65 | F | | 1146 | 1336 | 5.3 | 16 | 67 | 0 | O.K | 67 | 53 | 39 | O.K | 51956 | O.K | Example |
| 66 | | | 1095 | 1310 | 6.1 | 34 | 67 | 0 | O.K | 42 | 90 | 17 | N.G | 21833 | N.G | Compar. |
| | | | | | | | | | | | | | | | | Example |
| 67 | G | | 1356 | 1489 | 4.4 | 17 | 33 | 0 | O.K | 68 | 45 | 33 | O.K | 49633 | O.K | Example |
| 68 | | | 1349 | 1482 | 4.5 | 87 | 11 | 22 | N.G | 64 | 51 | 28 | N.G | 41167 | N.G | Compar. |
| | | | | | | | | | | | | | | | | Example |
| 69 | | | 1312 | 1471 | 5.2 | 48 | 33 | 0 | O.K | 45 | 88 | 11 | N.G | 16344 | N.G | Compar. |
| | | | | | | | | | | | | | | | | Example |
| 70 | H | | 1419 | 1785 | 5.0 | 21 | 33 | −11 | O.K | 73 | 39 | 50 | O.K | 89250 | O.K | Example |
| 71 | | | 1371 | 1771 | 5.8 | 41 | 22 | 0 | O.K | 49 | 73 | 33 | O.K | 59033 | O.K | Compar. |
| | | | | | | | | | | | | | | | | Example |
| 72 | I | | 1375 | 1667 | 4.6 | 15 | 33 | 0 | O.K | 67 | 48 | 50 | O.K | 83350 | O.K | Example |
| 73 | | | 1365 | 1659 | 4.6 | 95 | 0 | 33 | N.G | 65 | 51 | 50 | O.K | 82950 | O.K | Compar. |
| | | | | | | | | | | | | | | | | Example |
| 74 | | | 1321 | 1645 | 5.6 | 36 | 33 | 0 | O.K | 45 | 84 | 33 | O.K | 54833 | O.K | Compar. |
| | | | | | | | | | | | | | | | | Example |
| 75 | J | | 1774 | 2021 | 4.5 | 8 | 33 | −11 | O.K | 75 | 36 | 33 | O.K | 67367 | O.K | Example |
| 76 | | | 1723 | 2011 | 5.5 | 32 | 22 | 0 | O.K | 47 | 82 | 17 | N.G | 33517 | N.G | Compar. |
| | | | | | | | | | | | | | | | | Example |
| 77 | K | | 1432 | 1664 | 4.9 | 12 | 33 | 0 | O.K | 62 | 55 | 33 | O.K | 55467 | O.K | Example |
| 78 | | | 1372 | 1652 | 5.8 | 38 | 33 | 0 | O.K | 42 | 92 | 28 | N.G | 45889 | N.G | Compar. |
| | | | | | | | | | | | | | | | | Example |

TABLE 7

| | | | | | | Maximum tensile | | | | | | | | | | |
|---|---|---|---|---|---|---|---|---|---|---|---|---|---|---|---|---|
| | | | | | | residual stress in | | | | | | | | | | |
| | | | | | | surface layer region | | | | | | | | | | |
| | | | | | | up to depth of ¼ of | | Difference in | | | | Delayed | | Delayed | | |
| | | | | | | sheet thickness from | Delayed fracture | delayed fracture | | | Number of | fracture | | fracture | | |
| | | | | | | surface (MPa) | non-occurrence | non-occurrence | | Ratio of | cracks | non-occurrence | | non-occurrence | | |
| | | | | | | *-indicates | ratio of steel | ratios in steel | | KAM | introduced | ratio in cut | | ratio in cut end | | |
| Test | Steel | Product | YP | TS | EL | compressive residual | sheet base | sheet base | | value | during | end surface | | surface × TS | | |
| No. | type | type | (MPa) | (MPa) | (%) | stress | material (%) | material (%) | Evaluation | ≧1 (%) | cutting | (%) | Evaluation | (% · MPa) | Evaluation | Notes |
| 79 | L | EG | 1248 | 1498 | 4.7 | 7 | 67 | 0 | O.K | 65 | 50 | 33 | O.K | 49933 | O.K | Example |
| 80 | | | 1251 | 1493 | 4.8 | 91 | 33 | 34 | N.G | 67 | 48 | 33 | O.K | 49767 | O.K | Compar. |
| | | | | | | | | | | | | | | | | Example |
| 81 | | | 1213 | 1470 | 5.5 | 46 | 67 | 0 | O.K | 46 | 85 | 17 | N.G | 24500 | N.G | Compar. |
| | | | | | | | | | | | | | | | | Example |
| 82 | M | | 1395 | 1523 | 4.8 | −11 | 78 | −11 | O.K | 70 | 42 | 33 | O.K | 50767 | O.K | Example |
| 83 | | | 1356 | 1501 | 5.6 | 43 | 67 | 0 | O.K | 48 | 85 | 17 | N.G | 25017 | N.G | Compar. |
| | | | | | | | | | | | | | | | | Example |
| 84 | N | | 1254 | 1445 | 4.8 | 25 | 67 | −11 | O.K | 57 | 65 | 33 | O.K | 48167 | O.K | Example |
| 85 | | | 1210 | 1423 | 5.5 | 46 | 56 | 0 | O.K | 42 | 89 | 22 | N.G | 31622 | N.G | Compar. |
| | | | | | | | | | | | | | | | | Example |
| 86 | O | | 1179 | 1326 | 4.9 | −1 | 67 | 0 | O.K | 65 | 51 | 50 | O.K | 66300 | O.K | Example |
| 87 | | | 1182 | 1319 | 4.8 | 107 | 44 | 33 | N.G | 62 | 55 | 44 | O.K | 58622 | O.K | Compar. |
| | | | | | | | | | | | | | | | | Example |
| 88 | | | 1138 | 1311 | 5.8 | 38 | 67 | 0 | O.K | 42 | 91 | 33 | O.K | 43700 | N.G | Compar. |
| | | | | | | | | | | | | | | | | Example |
| 89 | P | | 1075 | 1245 | 5.4 | 11 | 100 | 0 | O.K | 71 | 45 | 50 | O.K | 62250 | O.K | Example |
| 90 | | | 1021 | 1228 | 6.2 | 51 | 100 | 0 | O.K | 44 | 82 | 33 | O.K | 40933 | N.G | Compar. |
| | | | | | | | | | | | | | | | | Example |
| 91 | Q | | 1301 | 1573 | 5.1 | 4 | 67 | 0 | O.K | 68 | 45 | 33 | O.K | 52433 | O.K | Example |
| 92 | | | 1253 | 1555 | 5.9 | 47 | 67 | 0 | O.K | 47 | 82 | 17 | N.G | 25917 | N.G | Compar. |
| | | | | | | | | | | | | | | | | Example |
| 93 | R | | 1583 | 1761 | 4.7 | 21 | 33 | 0 | O.K | 59 | 60 | 50 | O.K | 88050 | O.K | Example |
| 94 | | | 1540 | 1750 | 5.4 | 82 | 0 | 33 | N.G | 56 | 56 | 50 | O.K | 87500 | O.K | Compar. |
| | | | | | | | | | | | | | | | | Example |
| 95 | | | 1540 | 1750 | 5.4 | 43 | 33 | 0 | O.K | 38 | 91 | 33 | O.K | 58333 | O.K | Compar. |
| | | | | | | | | | | | | | | | | Example |
| 96 | S | | 1287 | 1558 | 6.3 | 10 | 67 | −11 | O.K | 72 | 45 | 33 | O.K | 51933 | O.K | Example |
| 97 | | | 1279 | 1552 | 6.4 | 102 | 33 | 23 | N.G | 67 | 45 | 28 | N.G | 43111 | N.G | Compar. |
| | | | | | | | | | | | | | | | | Example |
| 98 | | | 1220 | 1542 | 7.2 | 38 | 56 | 0 | O.K | 48 | 84 | 17 | N.G | 25700 | N.G | Compar. |
| | | | | | | | | | | | | | | | | Example |
| 99 | T | | 1495 | 1776 | 5.3 | 15 | 33 | 0 | O.K | 68 | 47 | 50 | O.K | 88800 | O.K | Example |
| 100 | | | 1459 | 1756 | 6.1 | 36 | 33 | 0 | O.K | 45 | 84 | 33 | O.K | 58533 | O.K | Compar. |
| | | | | | | | | | | | | | | | | Example |
| 101 | U | | 1773 | 2112 | 4.5 | −5 | 0 | 0 | O.K | 75 | 50 | 17 | N.G | 35200 | N.G | Compar. |
| | | | | | | | | | | | | | | | | Example |
| 102 | | | 1721 | 2090 | 5.5 | 45 | 0 | 0 | O.K | 49 | 89 | 0 | N.G | 0 | N.G | Compar. |
| | | | | | | | | | | | | | | | | Example |
| 103 | V | | 1389 | 1686 | 4.7 | 2 | 0 | 0 | O.K | 72 | 43 | 17 | N.G | 28100 | N.G | Compar. |
| | | | | | | | | | | | | | | | | Example |
| 104 | | | 1351 | 1672 | 5.6 | 53 | 0 | 0 | O.K | 45 | 81 | 6 | N.G | 9289 | N.G | Compar. |
| | | | | | | | | | | | | | | | | Example |

The following conclusions can be made on the basis of the results shown in Tables 4 and 5. In the examples in which the cold-rolled steel sheets CR were used which had chemical compositions specified by the present invention and which were subjected to correction with a leveler, that is, in Test No. 1, 4, 6, 9, 11, 13, 15, 18, 20, 23, 25, 27, 30, 32, 34, 37, 39, 41, 44, and 47, the resistance to delayed fracture of the steel sheet base material and end surface was improved because the region having a KAM value of 1° or more took 50% or more, and the maximum residual tensile stress in a surface layer region from a surface to a position at a depth of ¼ the sheet thickness was 80 MPa or less.

By contrast, in examples in which the cold-rolled steel sheets CR were used which were corrected by skin pass rolling, that is, in Test No. 2, 7, 16, 21, 28, 35, 42, and 45, the maximum residual tensile stress in a surface layer region from a surface to a position at a depth of ¼ the sheet thickness exceeded 80 MPa and the resistance to delayed fracture of the steel sheet base material degraded by comparison with that of the cold-rolled steel sheets CR of the examples in which the correction was performed with a leveler. This is apparently because the residual tensile stresses in the surface layer have increased. Further, in the cold-rolled steel sheets CR that were not subjected to correction, that is, in Test No. 3, 5, 8, 10, 12, 14, 17, 19, 22, 24, 26, 29, 31, 33, 36, 38, 40, 43, 46, and 48, the region having a KAM value of 1° or more took less than 50% and the resistance to delayed fracture of the end surface exhibited relative degradation even when the steel sheets of the same type were used. This is apparently because the number of cracks introduced during cutting was large.

Further in Test No. 19, 22, 38, 43, and 48 in which no correction was performed, the resistance to delayed fracture of the cut end surface degraded as compared with Test No. 18, 20, 37, 41, and 47 in which the correction was performed. However, even after the degradation, the resistance to delayed fracture of the cut end surface maintained a constant level. In Test No. 19, this is apparently because the steel type H was used and the amount of Cu added was comparatively large. In Test No. 22, this is apparently because the steel type I was used and the amount of Ni added was comparatively large. In Test No. 38, this is apparently because the steel type P was used and the amount of Ti and Ca added was comparatively large. In Test No. 43 and Test No. 48, this is apparently because the steel type R and the steel type T were used respectively, and the amount of Cu, Ni, Ca and the like added was comparatively large.

In the examples in which the cold-rolled steel sheets CR were used that did not have the chemical compositions specified by the present invention, that is, in Test No. 49 to 52, the resistance to delayed fracture degraded. Among them, in Test No. 49 and 50, the steel type U with an excessively large amount of Mn was used, which supposedly resulted in the degraded corrosion resistance and made it impossible to obtain good resistance to delayed fracture. In Test No. 51 and 52 the steel type V with an excessively large amount of Cr was used, which supposedly resulted in the degraded corrosion resistance and made it impossible to obtain good resistance to delayed fracture.

The following conclusions can be made on the basis of the results shown in Tables 6 and 7. In the examples in which the electrogalvanized steel sheets EG were produced by using the cold-rolled steel sheets CR which were subjected to correction with a leveler, that is, in Test No. 53, 56, 58, 61, 63, 65, 67, 70, 72, 75, 77, 79, 82, 84, 86, 89, 91, 93, 96, and 99, the resistance to delayed fracture of the steel sheet base material and end surface was improved because the region having a KAM value of 1° or more took 50% or more, and the maximum residual tensile stress in a surface layer region from a surface to a position at a depth of ¼ the sheet thickness was 80 MPa or less.

By contrast, in examples in which the electrogalvanized steel sheets EG were produced by using the cold-rolled steel sheets CR which were subjected to correction by skin pass rolling, that is, in Test No. 54, 59, 68, 73, 80, 87, 94, and 97, the maximum residual tensile stress in a surface layer region from a surface to a position at a depth of ¼ the sheet thickness exceeded 80 MPa and the resistance to delayed fracture of the steel sheet base material degraded by comparison with that of the steel sheets of the examples in which the correction was performed with a leveler. This is apparently because the residual tensile stresses in the surface layer have increased. Further, in the examples in which the electrogalvanized steel sheets EG were produced by using the cold-rolled steel sheets CR which that were not subjected to correction, that is, in Test No. 55, 57, 60, 62, 64, 66, 69, 71, 74, 76, 78, 81, 83, 85, 88, 89, 92, 95, 98, and 100, the region having a KAM value of 1° or more took less than 50% and the resistance to delayed fracture of the end surface exhibited relative degradation even when the steel sheets of the same type were used. This is apparently because the number of cracks introduced during cutting was large.

Further in Test No. 71, 74, 95, and 100 in which no correction was performed, the resistance to delayed fracture of the cut end surface degraded as compared with Test No. 70, 72, 93, and 99 in which the correction was performed. However, even after the degradation, the resistance to delayed fracture of the cut end surface maintained a constant level. In Test No. 71, this is apparently because the steel type H was used and the amount of Cu added was comparatively large. In Test No. 74, this is apparently because the steel type I was used and the amount of Ni added was comparatively large. In Test No. 95 and Test No. 100, this is apparently because the steel type R and the steel type T were used respectively, and the amount of Cu, Ni, Ca and the like added was comparatively large.

In the examples in which the electrogalvanized steel sheets EG were produced by using the cold-rolled steel sheets CR that did not have the chemical compositions specified by the present invention, that is, in Test No. 101 to 104, the resistance to delayed fracture degraded. Among them, in Test No. 101 and 102, the steel type U with an excessively large amount of Mn was used, which supposedly resulted in the degraded corrosion resistance and made it impossible to obtain good resistance to delayed fracture. In Test No. 103 and 104 the steel type V with an excessively large amount of Cr was used, which supposedly resulted in the degraded corrosion resistance and made it impossible to obtain good resistance to delayed fracture.

### INDUSTRIAL APPLICABILITY

The high-strength steel sheet in accordance with the present invention contains, by mass %, C: 0.12% to 0.40%, Si: 0% to 0.6%, Mn: more than 0% to 1.5%, Al: more than 0% to 0.15%, N: more than 0% to 0.01%, P: more than 0% to 0.02%, S: more than 0% to 0.01%, and has a martensite single-phase structure, wherein a region having a KAM value (Kernel Average Misorientation value) of 1° or more occupies 50% or more, and a maximum residual tensile stress in a surface layer region from a surface to a position at a depth of ¼ the sheet thickness is 80 MPa or less. As a result, the steel sheet excels in the resistance to delayed fracture of the cut end surface and the steel sheet base material.

1. A high-strength steel sheet comprising, by mass %,
C: 0.12% to 0.40%,
Si: 0% to 0.6%,
Mn: more than 0% to 1.5%,
Al: more than 0% to 0.15%,
N: more than 0% to 0.01%,
P: more than 0% to 0.02%,
S: more than 0% to 0.01%,
and having a martensite single-phase structure, wherein
a region having a KAM value (Kernel Average Misorientation value) of 1° or more occupies 50% or more, and a maximum residual tensile stress in a surface layer region from a surface to a position at a depth of ¼ the sheet thickness is 80 MPa or less.

2. The high-strength steel sheet according to claim 1, further comprising one or more selected from the group consisting of Cr: more than 0% to 1.0%, B: more than 0% to 0.01%, Cu: more than 0% to 0.5%, Ni: more than 0% to 0.5%, Ti: more than 0% to 0.2%, V:
more than 0% to 0.1%, Nb: more than 0% to 0.1%, and Ca: more than 0% to 0.005%.

3. The high-strength steel sheet according to claim 1, which is a galvanized steel sheet in which a galvanized layer is formed on the surface of the steel sheet.

4. A process for producing a high-strength steel sheet, comprising:
heating a steel sheet having the chemical composition according to claim 1 in a temperature range from an Ac₃ transformation point to 950° C., holding the steel sheet for 30 sec or more in this temperature range, then quenching the steel sheet from a temperature range of 600° C. or higher, tempering the steel sheet for 30 sec or more at 350° C. or less, and then performing correction with a leveler.

5. The production process according to claim 4, wherein an elongation rate during correction with the leveler is 0.5% to 1.8%.
